(19) United States
(12) Patent Application Publication
(10) Pub. No.: US 2026/0359791 A1
(43) Pub. Date: Nov. 12, 2026

(54) SYSTEM AND METHODS FOR DATA FRAUD DETECTION IN HIRING PROCESSES

(71) Applicant: JPMorgan Chase Bank, N.A., New York, NY (US)

(72) Inventors: Ming Zhu, Fremont, CA (US); Fei Chen, Plano, TX (US); Yumei Xiong, Brentwood, CA (US); Jinguang Zhou, Santa Clara, CA (US); SoonJin-Charles Lim, San Jose, CA (US); Paulino Reyes, San Jose, CA (US); David Verdugo, San Jose, CA (US); Zhaoyu Qian, Belmont, CA (US); Sha Yan, Burlingame, CA (US); Zefang Liu, Mountainview, CA (US); Yue Shi, Sunnyvale, CA (US)

(73) Assignee: JPMorgan Chase Bank, N.A., New York, NY (US)

(21) Appl. No.: 19/642,303

(22) Filed: Apr. 8, 2026

Related U.S. Application Data
(60) Provisional application No. 63/785,960, filed on Apr. 9, 2025.

(51) Int. Cl. G06Q 10/1053; G06F 40/30; G06V 40/20

(52) U.S. Cl. CPC G06Q 10/1053; G06F 40/30; G06V 40/20

(57) ABSTRACT

Provided is a system and methods for detecting and preventing data fraud in the human resources hiring process. The system includes a data processing module that extracts raw resume data from resumes received using machine learning, an information extraction module that retrieves key individual data from the extracted text and converts it into a structured format as source data for downstream processing, a reference data retrieval module that queries relevant individual data as reference data from external data sources using data output in the structured format from the information extraction module, a comparison module that converts source data and reference data into vector embeddings using a machine learning model, and conducts a semantic similarity search to calculate similarity scores between the vector embeddings, and a recommendation module that generates validation recommendations based on the similarity scores.

### CROSS-REFERENCE TO RELATED APPLICATIONS

This application claims priority to U.S. Application Ser. No. 63/785,960 filed Apr. 9, 2025, which is herein incorporated by reference.

### FIELD OF TECHNOLOGY

The present disclosure relates to the field of human resources (HR) technology. More specifically, the disclosure focuses on detecting and preventing data fraud in HR hiring processes with the use of artificial intelligence (AI) and machine learning (ML) technology.

### BACKGROUND

In the field of human resources, the hiring process is an essential function that involves the evaluation and validation of candidate information. Traditionally, this process has been labor-intensive, requiring significant manual effort to review resumes, verify credentials, and cross-reference data from various sources. As the volume of applications continues to grow, HR departments face increasing challenges in efficiently managing and processing this information. The reliance on manual methods not only consumes time and resources but also introduces the potential for human error, which can lead to inaccuracies in candidate assessments.

Existing solutions often lack the capability to effectively address the complexities of modern resume fraud and interview cheating. These solutions may not fully leverage the advancements in AI and ML technologies, which have the potential to automate and enhance the accuracy of data validation processes. The limitations of current systems highlight the need for innovative approaches that can streamline the hiring process, reduce the risk of fraud, and improve the overall efficiency and reliability of candidate evaluations.

### SUMMARY

The disclosure provides a system and method designed to detect and prevent data fraud in the human resources hiring process. According to one embodiment, the system comprises several software modules, including a data processing module that extracts raw resume data from resumes received using ML, an information extraction module that retrieves key individual data from the extracted text and converts the data into a structured format as source data for downstream processing, and a reference data retrieval module that queries relevant individual data as reference data from external data sources using data output in the structured format from the information extraction module. Also included is a comparison module that converts source data and reference data into vector embeddings using an ML model, and conducts a semantic similarity search to calculate similarity scores between the vector embeddings. A recommendation module generates validation recommendations based on the similarity scores.

In another embodiment, provided is a method utilizing the above-mentioned system to detect and prevent data fraud in the hiring process.

In another embodiment, provided is a method for verifying reference contacts provided by job applicants.

In yet another embodiment, provided is a method for performing job interviews for applicants.

In yet other embodiments, tangible computer-readable mediums having stored thereon, computer-executable instructions that, if executed by a computing device, cause the computing device to perform the above-mentioned methods.

Additional features, modes of operations, advantages, and other aspects of various embodiments are described below with reference to the accompanying drawings. It is noted that the present disclosure is not limited to the specific embodiments described herein. These embodiments are presented for illustrative purposes only. Additional embodiments, or modifications of the embodiments disclosed, will be readily apparent to persons skilled in the relevant art(s) based on the teachings provided.

### BRIEF DESCRIPTION OF THE DRAWINGS

Illustrative embodiments may take form in various components and arrangements of components. Illustrative embodiments are shown in the accompanying drawings, throughout which like reference numerals may indicate corresponding or similar parts in the various drawings. The drawings are only for purposes of illustrating the embodiments and are not to be construed as limiting the disclosure. Given the following enabling description of the drawings, the novel aspects of the present disclosure should become evident to a person of ordinary skill in the relevant art(s).

FIG. 1 illustrates a diagram of a system according to embodiments of the present disclosure.

FIG. 2 illustrates a flow diagram of a method utilizing the above-mentioned system for verifying resumes to detect and prevent data fraud in the hiring process, according to embodiments of the present disclosure.

FIGS. 3A and 3B respectively illustrate a flow diagram of a method for extracting raw resume data and an example of raw resume data and extracted text according to embodiments of the present disclosure.

FIG. 4 illustrates flow diagram of a method for the generation of machine-readable text format from the raw resume data according to embodiments of the present disclosure.

FIG. 5 illustrates examples of the generation of machine-readable text format from text retrieved from raw resume data according to embodiments of the present disclosure.

FIG. 6 illustrates in example of reference data and query of keywords according to embodiments of the present disclosure.

FIG. 7 illustrates a flow diagram of a method for performing a semantic similarity search according to one or more embodiments of the present disclosure.

FIGS. 8A and 8B respectively, illustrate a flow diagram of a method for calculating psychometric measurements and a resultant graph according to embodiments of the present disclosure.

FIG. 9 is a diagram of a system for conducting job interviews virtually according to one or more embodiments of the present disclosure.

FIG. 10 is a flow diagram illustrating a method for conducting job interviews for applicants using the system show in FIG. 9, according to another embodiment of the present disclosure.

FIG. 11 is a flow diagram illustrating a more detailed method of that shown in FIG. 10, for conducting job interviews using the system shown in FIG.

FIG. 12 illustrates a block diagram of an exemplary computer system for implementing the system and methods according to embodiments of the present disclosure.

### DETAILED DESCRIPTION

In the following detailed description of the present disclosure, reference is made to the accompanying drawings that form a part hereof, and in which is shown by way of illustration how one or more embodiments of the disclosure may be practiced. These embodiments are described in sufficient detail to enable those of ordinary skill in the art to practice the embodiments of this disclosure, and it is to be understood that other embodiments may be utilized and that process, electrical, and structural changes may be made without departing from the scope of the present disclosure.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

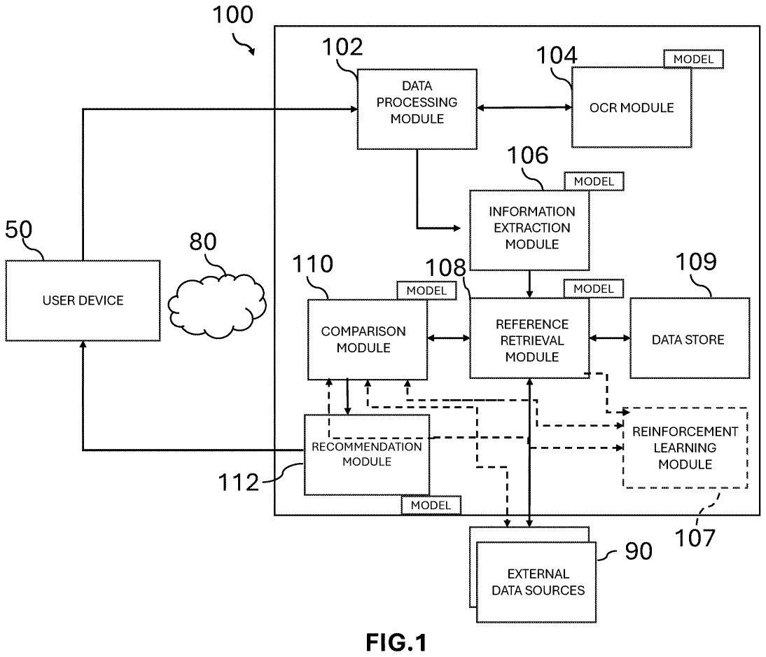

FIGS. 1-12 provide a detailed explanation of the components and processes involved in the systems and methods for verifying resumes and references and performing job interviews to detect and prevent data fraud. As used herein, the term “resumes” is intended to broadly encompass a range of employment-related materials that convey an individual's qualifications, experience, and suitability for a position. This includes, but is not limited to, traditional resumes as well as cover letters, job applications, and job profiles. Moreover, the systems or methods described herein may also apply to curricula vitae (CVs), as well as reference letters, recommendation forms, employment histories, and digital representations such as social media profiles (e.g., LinkedIn®), professional biographies, and video resumes or introductions, and any other employment-related information in various formats.

In some embodiments, the present invention may further encompass documentation that reflects a candidate's skills and credentials, such as certifications, licenses, academic records or transcripts.

In FIG. 1, for example, system 100 is designed to automate and streamline the verification processes using artificial intelligence (AI) and machine learning (ML) models, natural language processing (NLP), agent function calling, vector embeddings and semantic similarity processes, further discussed below.

In some embodiments, artificial intelligence (AI) agents can be implemented for within the reference retrieval module 108, the comparison module 110 and the recommendation module 112 (as depicted in FIG. 1) for the task of reference retrieval, comparison, recommendations processes.

An AI agent can be defined as a piece of software which receives input, processes the input, and returns output. The format in which input can be in is not limited, and can be any type of text or image. Because of the reasoning ability of language models, AI agents can communicate in a way similar to how humans work together as a group where each human individual handles a different task. For example, one agent receives extracted information input, sends to language models along with instructions (or prompt templates), and receives formatted output of name, job, school related data. The data can be forwarded to other agents to run a fine-grained query for specific query, and another agent can decide to either continue or stop the query or ask questions.

Also, natural language processing (NLP) can be used in embodiments of the present disclosure, NLP is a kind of machine learning or artificial intelligence technology which can understand, reason, process text data which is similar to what human communication, such as speaking or writing. The type of language can be different depending on the NLP models uses. Considering the various formats (text, pdf, image, audio, video) of resumes HR recruiters receive, NLP can first convert input into text and then standardize the text into format expected by agents. Using pre-defined rules for input and output multiple agents (i.e., multiple pieces of software) can interact with each other depending on the output values. These interactions of multiple software programs act as standard software function calls but can handle text input and provide standardized output. Moreover, the interactions can be chained up to process complicated tasks similar to how human handles multiple tasks, looks up information, tries different methods, and finally reaches the solutions.

According to one embodiment, as shown in FIG. 1, the system 100 comprises several software modules, including a data processing module 102, an optical character recognition (OCR) module 104, an information extraction/NLP module 106, a reference retrieval module 108, a data store 109, a comparison module 110, and a recommendation module 112. The modules of the system may operate in a coordinated pipeline, wherein outputs from one module are used as inputs to subsequent modules, enabling automated end-to-end processing of resume verification and interview evaluation tasks.

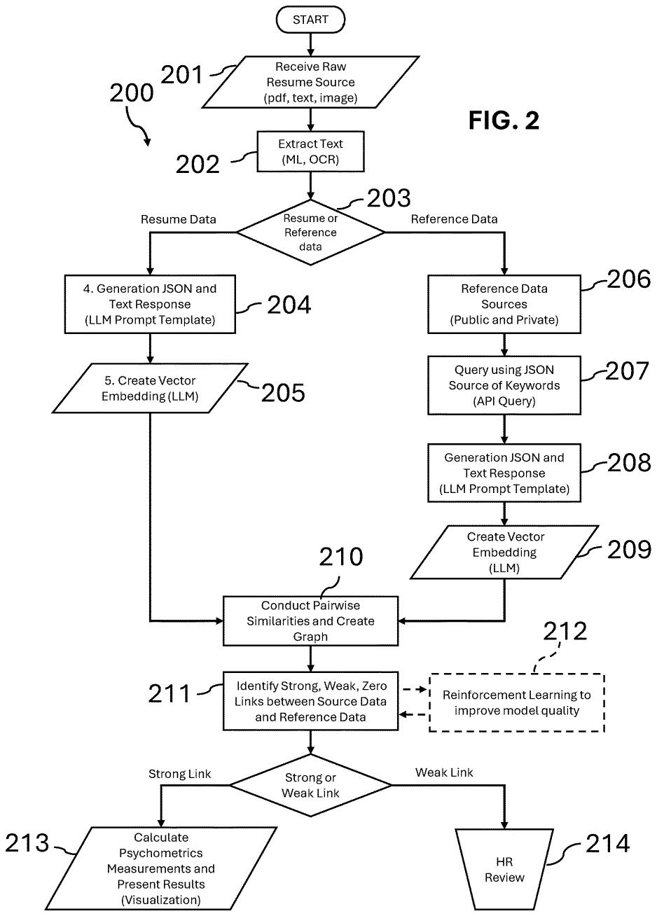

FIG. 2 illustrates a method 200 utilizing the system 100 for verifying resumes when HR recruiters receive resumes from job applicants to the end when resume contents are evaluated using AI/ML technologies aiming to detect and identify potential data fraud, discrepancy, mis-information presented on resumes during the job applicants evaluation and hiring process. Details regarding the system 100 and method 200 will be discussed below with reference to FIGS. 1 and 2.

According to embodiments of the present disclosure, resumes may be received by an HR recruiter via a user device 50 in different formats such as paper, digital, or image format. If the resume is received in paper format, it may be scanned and converted into PDF® format and then converted into text format. The user device 50 is in communication with the system 100 via a communication network 80. According to embodiments, the communication network 80 may be a cloud network.

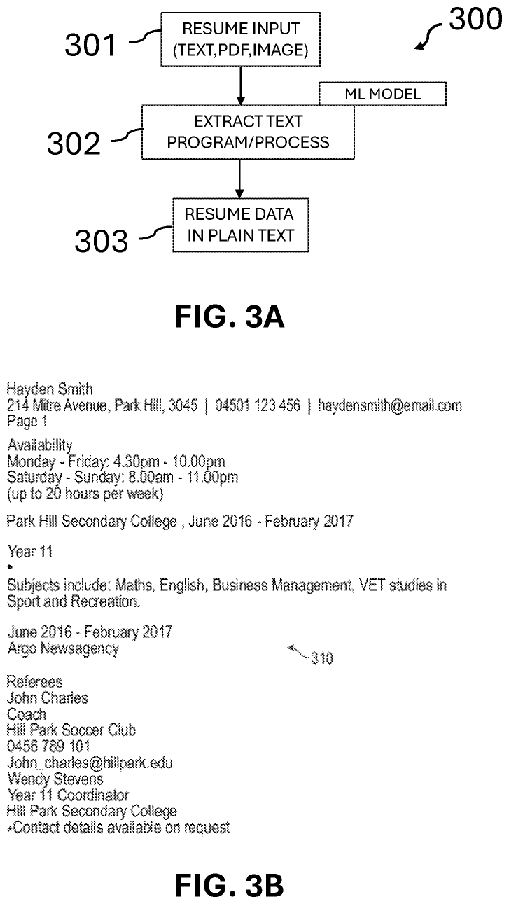

The data processing module 102 extracts raw text data from the resume files in various formats using ML techniques and large language models (LLMs). The data processing module 102 may use the optical character recognition (OCR) module 104, which includes an OCR tool which uses models to extract raw resume text data from image files, text, or PDF® documents (as depicted in FIG. 3 discussed below). The resume documents, e.g., scanned paper resumes, PDFs, or images containing text are converted into machine-readable, editable text via the OCR module 104. The data processing module 102 can be a software algorithm, hardware component, or a combination of both, according to the embodiments. It can also include multiple processing modules. In this text data extraction process, once the received resume files are uploaded to the data processing module 102 and the raw resume data (e.g., a scanned resume as image format file) is converted into the editable text, the editable text data is forwarded to information extraction/NLP module 106 wherein machine learning (ML) models which have natural language processing, image-to-text, voice-to-text ability to extract text on resume files. To improve high accuracy and low data loss multiple of expert models (MOE) can be used and extracted text can be cross validated, and any outliers can be excluded from next processing steps.

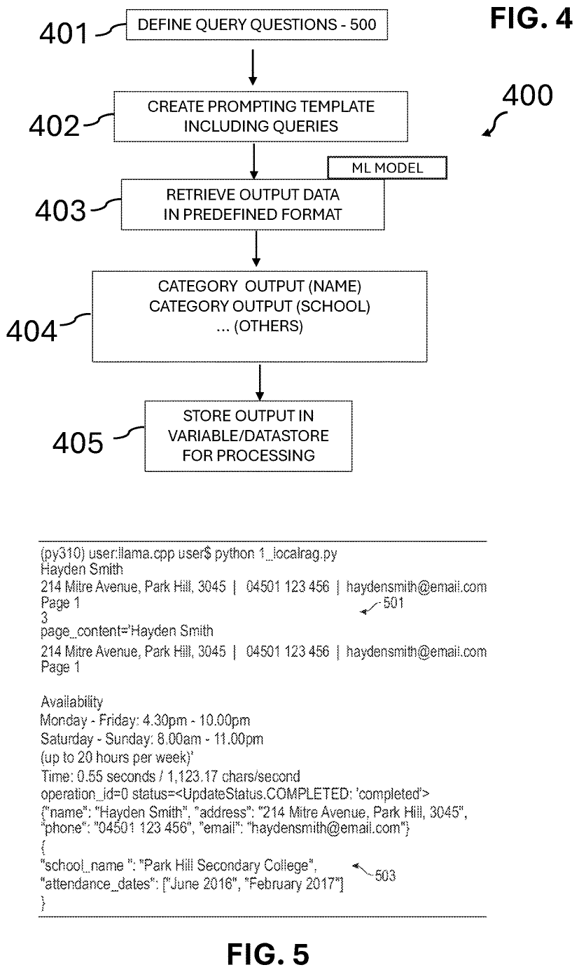

Once the raw text data is extracted, an information extraction/NLP module 106 retrieves key individual data from the extracted text including, for example, primary individual data such as educational background, employment history, job titles, and skillset alignment. This data is converted into a structured format (e.g., JavaScript Object Notation (JSON) format, Extensible Markup Language (XML), key-value pairs in dictionaries) for data transmission and further processing (as depicted in FIG. 4). The JSON format includes key-value pairs to facilitate data manipulation.

The keys are strings shown in double-quotes. The values may be strings, numbers, Booleans, null, arrays, or objects according to the embodiments (as depicted in FIGS. 4 and 5A). AI language models, along with prompting templates (as depicted in FIG. 5A) and other engineering techniques, are employed to achieve this outcome based on the instructions provided. The instructions can be defined as a text template where certain names of functions, tasks, processes along with steps in text format using common prompting engineering techniques. These instructions, or a block of text using specific format and field names (for examples {text input}, {check school task}, {category A}), can be created and stored internally with software programs, or externally in data stores or databases to accommodate new updates requirements if needed. These instructions or text content are often reviewed and updated to improve performance and reduce errors. According to one embodiment, the input and output data can be evaluated by human engineers for quality and accuracy regularly. According to another embodiment, use of reinforcement learning (RL) can be another approach. As shown in FIG. 1, an optional reinforcement learning module 107 may be provided to evaluate output results against expected results. This improvement process is iterative for continuous improvement. For example, at first a policy can be defined to reward the agent's actions if proper, accurate, factual output are created, and penalize while penalizing the agents if improper or unrelated output are created. An incremental weight can be applied to the agent actions iteratively with using a self-feedback loop. Additionally, it is also possible to collect input and output data with high correlations to fine-tune custom models to improve model predictions. In some embodiments, the reinforcement learning module is configured to receive output results generated by one or more of the information extraction module, comparison module, and recommendation module, and compare the output results with expected results to determine accuracy. The reinforcement learning module may apply a reward value to accurate outputs and a penalty value to inaccurate or unrelated outputs, and iteratively update one or more model parameters based on the reward and penalty values using a feedback loop. The reinforcement learning module may further adjust weights associated with vector embeddings, similarity scoring, or recommendation thresholds to improve system performance over time.

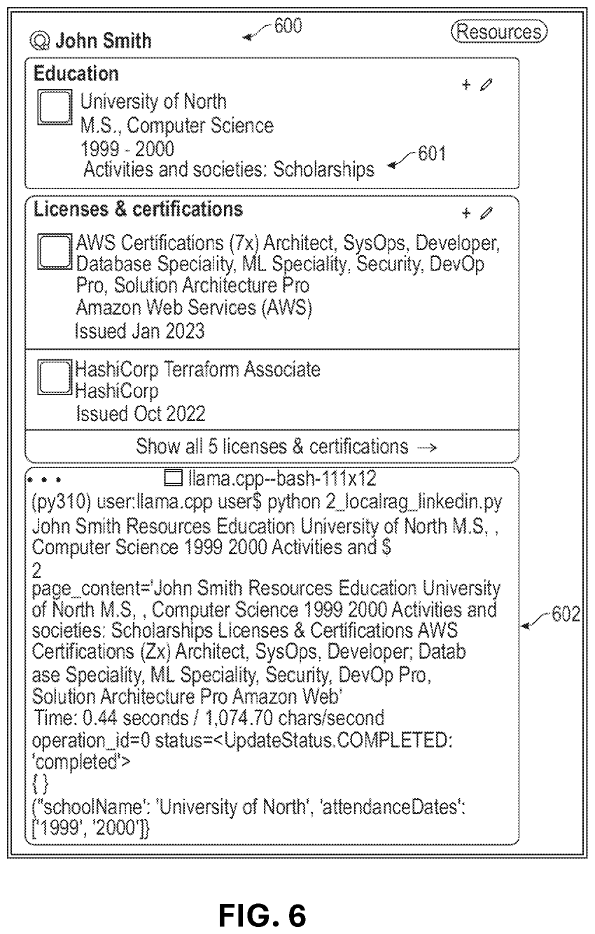

The reference data retrieval module 108 is in communication with the information extraction module 106 and using models may query relevant individual data in parallel from various external data sources 90 using the JSON text output received (as depicted in FIG. 6). The data is stored in the data store 109. The external data sources 90 can be public, paid, proprietary or custom data sources, for example, LinkedIn®, Facebook®, Accredify®, and the like. The external data sources 90 may also be proprietary HR databases or datasets or other relevant data sources such as conference talks, tech blogs, Stack Overflow® discussions, and GitHub® contributions.

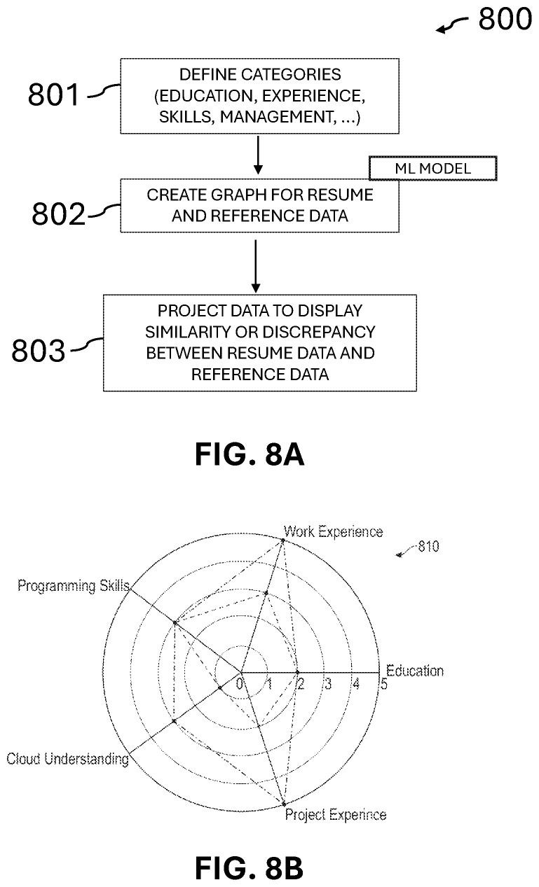

The comparison module 110 is in communication with the reference retrieval module 108 and optionally in direct communication with the external data sources 90. The comparison module 110 receives both the source and reference data from the external data sources 90 and converts them into vector embeddings using an ML model (as described below). The comparison module 110 also conducts a semantic similarity search by calculation of similarity scores (as depicted in FIGS. 8A and 8B discussed below) e.g., by calculation of a cosine similarity.

Machine learning (ML) algorithms operate and process using numbers, text source data and reference data need to be converted to numerical data values in the format of vectors. These vectors are list of numbers for ML algorithms to operate. Using vector embeddings, text or image data, or objects, can be quantified by how close these objects are to each other as points in vector space. Here the system relies on vector embeddings to measure if text data on resume and reference data from other sources (reliable and managed) are similar and how similar they are, to identify the distances between them, and for true fact evaluation. In some embodiments, the vector embeddings represent numerical representations of text data in a multi-dimensional vector space, enabling efficient computation of similarity metrics between source data and reference data. The use of vector embeddings allows the system to perform semantic comparisons beyond exact keyword matching, thereby improving detection of discrepancies and reducing false positives.

The similarity scores indicate how similar or different the source data is from the reference data. The scoring information can be stored, for example, in the data store 109. By way of example, and not limited hereto, the scoring can be performed using an algorithm, such as:

$$f ( query , value ) ( q , k ) \to ( \begin{matrix}source & reference \\ {s}_{0} & {r}_{0} \\ {s}_{1} & {r}_{1} \\ \cdot & \cdot \\ \cdot & \cdot \\ {s}_{0} & {r}_{0} \\ pairwise & similarity\end{matrix} ) \to {\sum (}_{i = 0}^{n} ( \begin{matrix}strong \\ weak \\ zero\end{matrix} ) links ) \to \\ output$$

Based on the scoring, there will be one numeric value generated between zero (0), representing different, and one (1) representing similar or identical. Scoring can also provide weight to multiple keywords according to an embodiment. For example, for default keywords such as educational background and work experience, the default weight can be 0.5 for a total of two keywords. Default thresholding of acceptance is approximately 0.85, and of rejection is approximately 0.70, which would trigger a fraud alert (e.g., a cosine similarity of 0.72 as depicted in FIG. 8B). Default keywords, weight, and thresholds can be configurable.

The scoring algorithm is defined as a combination of multiple evaluations. The data used to evaluate and generate the resultant score is based on matching similarities between resume data and reference data, exact matches of keywords or phrases, and values that are different between the resume data and the reference data. The score can also be in a range of approximately 0.0 to approximately 1.0, where 1.0 represents the highest similarity, and 0.0 represents the lowest or zero similarity to indicate a strong, weak, or zero (0) link, as shown above.

According to an embodiment, Python programming may be used to perform the operations of method 200 shown in FIG. 2.

The recommendation module 112 receives the similarity scores from the comparison module 110 and based on the scoring algorithm and the thresholds mentioned above, the recommendation module 112 can generate the following types of recommendation categories:
Approve: a score is above the threshold of acceptance and therefore credible.
Decline: a score is below threshold of rejection and likely fraudulent.
Follow-up: a score is in between, and will require follow-up by an HR review.

These recommendations are based on similarity scores to ensure fairness, reduced bias, transparency, and responsibility. The recommendations may include data points from the resume, reference data sources, and any custom data sets used. This data is stored in a data storage (e.g., data store 109). According to an embodiment, the custom datasets can be datasets that HR recruiters use which are not available or cannot be included in the language model training or inferencing because of data privacy, risk, or compliance requirements. Such an example includes company internal employee profile database which can be queried when existing employees are interested at applying internal job openings. Depending on the data policy and compliance, the custom dataset can be customized while using access control mechanism to restrict data addition, modification, and deletion.

By way of example, if a score falls within the follow-up category, an AI agent can perform the following operations, for example, generate an email to be sent to the applicant to inquire about the concern or discrepancy, and give that applicant a chance to clarify the mismatch (e.g., if it's a different person with the same name on LinkedIn® etc.). The AI agent may also initiate an application programming interface (API) call to verify information, such as a call to the University to perform an official degree check, suggest that HR contact the applicant for clarification, and/or suggest an in-depth screening, such as a paid background check.

According to an embodiment, the system 100 also provides multi-language support to be able to translate the language used in a resume into another language by integration of a translation API that supports voice and text.

The method 200 for verifying a resume, as shown in FIG. 2, will now be described with reference to system 100 of FIG. 1. The method 200 begins at operation 201, where resumes are received and raw resume data is retrieved, including text data and images and PDF® documents. From operation 201, the process continues to operation 202, where the raw resume data is converted and extracted using ML techniques and LLMs, including the use of an OCR tool, to convert the resume documents, e.g., scanned paper resumes, PDFs, or images containing text-into machine-readable text for further data processing.

From operation 202, the process continues to operation 203, where it is determined whether a resume or reference(s) is being verified. The verification process begins in parallel to process both resume data and reference data found associated with the source resume data when both are presented, but can be only one of them depending on job description or requirements according to some embodiments depending on the output from operation 202. If it is source resume data, the process continues to operation 204, where key information is extracted from the resume data received and converted. This includes retrieving primary individual data such as educational background, employment history, job titles, and skillset alignment and converting the data into JSON format.

Operation 204 also includes extracting keyword and value data from the resume for an AI agent reference data check and similarity comparison. The AI agent will have default keywords such as educational background and work experience and allow configurable keywords by a user (e.g., an HR recruiter) based on specific use cases. For example, if the user is seeking to fill a position with an applicant having programming experience then “programming” may be configured as a keyword.

In parallel, at operation 206, reference data, including, e.g., public and private data, is retrieved from images, screenshots, web page scraping text data and database records, or custom databases containing historical records for comparison. The JSON output from operation 204 is then used as input to query relevant individual data in operation 207 from external data sources.

In this operation, AI language models and prompting techniques are used to extract the information and generate the necessary data into JSON format at operation 208, whereby the reference data closely matches and is similar to the key information from the resume that is also in JSON format (from operation 204). According to one embodiment, to analyze the resume data, a keyword list can be configured from pre-defined common words for specific areas or fields and generated at runtime using content clustering, topic modeling, or most or least appeared words on the resume.

The method 200 then continues to operations 205 and 209, where the source data and reference data are converted into vector embeddings using ML models, as depicted in FIG. 8A and discussed below.

At operation 210, a semantic similarity search is then conducted between the vector embeddings to calculate similarity scores using a scoring algorithm as described above. According to one embodiment, cosine similarity algorithms can be used to determine how similar or different the source data is from the reference data. At operation 211, it is determined, based on the score, whether there is a strong, weak, or zero (0) link between the resume source data and the reference data. This information is stored in a data store (e.g., data store 109 depicted in FIG. 1). An optional reinforcement learning operation can be implemented at operation 212.

Based on the link determined, a recommendation is provided in one of the following recommendation categories: Approval, Decline, or Follow-up. The process continues to operation 213 when a strong link exists-indicative of an approval. Alternatively, the process continues to operation 214 when a weak or zero (0) link exists, which is indicative of a Decline or Follow-up. These recommendations may include data points from the resume, applicable reference data sources, and any custom datasets.

According to an embodiment, the method shown in FIG. 2 can also be used to verify reference contacts provided by an applicant. Typically, applicants are required to provide around three (3) reference contacts. The above method can be applied to verify the integrity of these references, which in turn affects the applicant's credibility. The information provided in association with each reference contact can be compared to reference data found from external data sources associated with each reference contact to perform the verification process. Reference data verification can be considered as a support function to cross validate applicant's resume data, and can be optional. When reference contact or information is available, the system may run query to retrieve and compare results, following same process illustrated on FIG. 2.

FIGS. 3A and 3B illustrate a method for extracting resume data to be performed at the data processing module 102 and the information extraction/NLP module 106, as shown in FIG. 1, and an example of raw resume data and extracted text, respectively according to embodiments of the present disclosure. As shown in FIG. 3A, method 300 includes receiving the resume input at operation 301, and then converting the raw resume data into editable text at the data processing module 102 and extracting the raw resume data via an text extraction process and then outputting resume data in plain text at operation 303 at the information extraction/NLP module 106. As shown in FIG. 3B, raw resume data is retrieved from a resume received in a PDF® format. Key information 310, as shown, can be extracted from the resume, including name, address, educational background, work experience, job titles, and skillsets of the applicant.

FIG. 4 illustrates an example of the extraction of keywords and values according to embodiments of the present disclosure.

FIGS. 4 and 5 respectively illustrate a method 400 and examples of the generation of machine-readable text, by generating the key information in a machine-readable format, such as JSON, to create a prompting template. As shown in FIG. 5, the method 400 starts at operation 401 where query questions are defined using text input similar to when humans ask questions. Next, at operation 402, a prompting template may include a search query to extract the job applicant's name, physical address, email address and school name and school address from raw resume data 501 in JSON format, e.g., as shown in FIG. 5. Then, at operation 403, a language model (e.g., ML model) is used to run the query using vector embeddings from text data. The language model is able to retrieve output data (e.g., related data) and generate a response (also in e.g., JSON format), such as the applicant name and school name and other information 503 as shown in FIG. 5.

Further shown in FIG. 4, at operation 404, the system 100 (depicted in FIG. 1) outputs category outputs such as name, school, and others, for example, as shown in FIG. 6, the applicant's name 600, school information 601 are generated into JSON format in a text response 602 at operation 405 and the output is stored in a data store (e.g., data store 109) depicted in FIG. 1, for further processing.

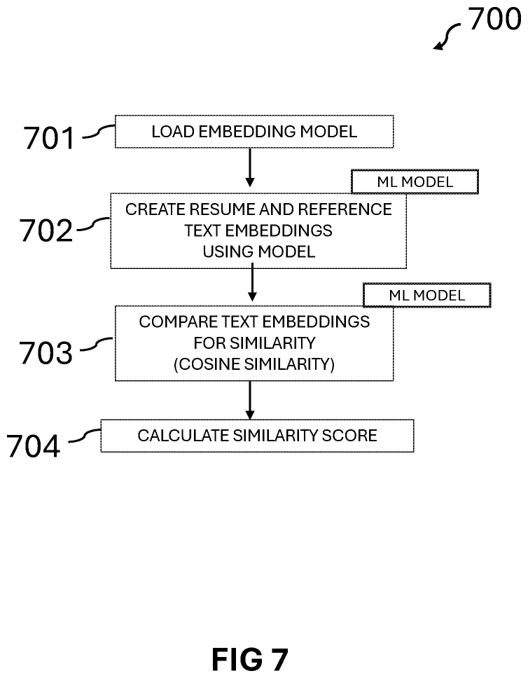

FIG. 7 illustrates a method for performing a semantic similarity search according to one or more embodiments of the present disclosure. As shown in FIG. 7, at operation 701 embedding model is loaded to the comparison module 110 (depicted in FIG. 1) to conduct a semantic similarity search using the vector embeddings. In operation 702, resume and reference text embeddings are created using the model. Then, in operation 703, the text embeddings are compared for similarity. As previously mentioned, the semantic similarity search can be conducted by calculating cosine similarity at operation 703 and then determining the similarity results, and calculating a similarity score at operation 704. For example, if text inputs include the word “school” or “college” and dates, these two words have a score of 0.72 similarity (in the scale of 1.0 being a match, 0.0 being different or not quite closely matched

FIGS. 8A and 8B respectively illustrate a method 800 to perform a calculation of psychometrics measurements using comparison data to produce the resultant graph 910 as depicted in FIG. 8B. As shown in FIG. 8A, at operation 801, categories are defined such as (education, experience, skills and management, etc., Then at operation 802, a graph is created for the resume and reference data for evaluation. Finally, at operation 803, data is displayed (e.g., on the graph) to show the similarity or discrepancy between the resume data and the reference data. As shown in FIG. 8B, graph 802 (e.g., a spider chart) is produced that includes various measurements associated with work experience, education, project experience, programming skills, and cloud understanding of an applicant. The graph 802 represents the resume information provided versus actual or real answers. In some embodiments, the graph provides a visual representation of similarity scores across multiple predefined categories, and enables identification of discrepancies between resume data and reference data in a structured and interpretable format. The visualization may be dynamically generated based on computed similarity scores and updated in real-time.

Embodiments of the present disclosure can also be implemented for performing job interviews with applicants. Remote interviewing has become increasingly popular in recent years. However, new challenges have emerged with performing video interviews. HR recruiters have observed instances where applicants exhibit noticeable pauses, look away or appear to be reading, and provide seemingly “perfect” answers. This raises concerns that the applicant, or a third party may be using another device to consult AI tools, such as ChatGPT®, or perform searches using search engines, such as Google®, to obtain their answers to questions asked.

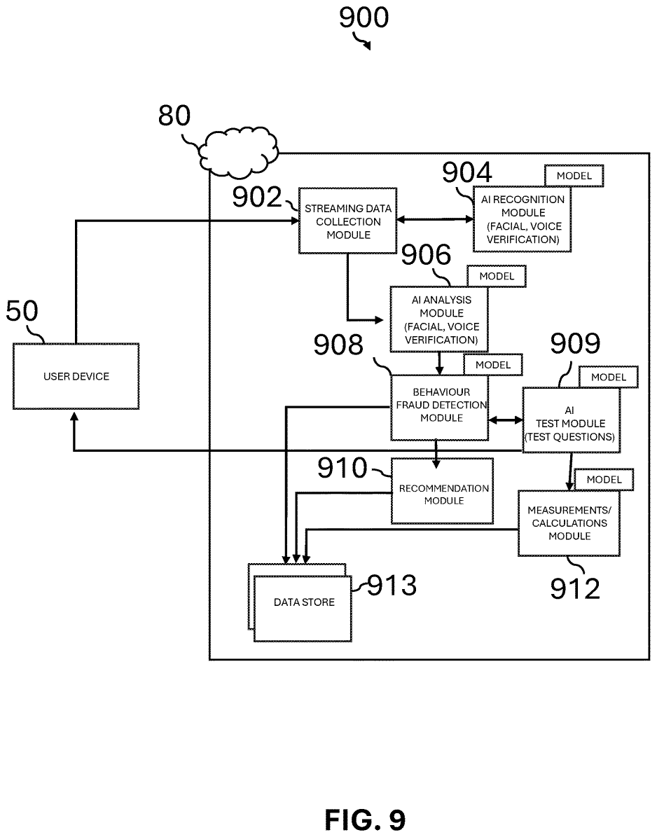

FIG. 9 is a system 900 for conducting job interviews for job applicants according to one or more embodiments of the present disclosure. Similar to system 100 of FIG. 1, the system 900 comprises several software modules, including a streaming data collection module 902, an AI recognition module 904 and associated models, an AI analysis module 906 and associated models, a behavior fraud detection module 908, an AI test module 909, a recommendation module 910, a measurements/calculations module 912 and a data store 913.

When conducting job interviews virtually, HR recruiters may evaluate the job applicants using the system 900 which employs AI/ML technologies aiming to detect and identify potential data fraud, discrepancy, and mis-information presented on resumes during the job applicants evaluation and hiring process. The HR recruiter may access the system 900 at a user device 50 via a communication network 80 (as also shown in FIG. 1). Therefore, the details thereof are omitted here. Data is collected including video, audio and streaming data at the streaming data collection module 902, the data is then processed using a ML model for AI facial and voice recognition at the AI recognition module 904. After the AI facial and voice data is processed, it is then analyzed via the AI analysis module 906 Here, the system 900 will analyze facial movements and voice patterns of the job applicant to determine if any suspicious activities are occurring e.g., the applicant turning off the camera, suspicious eye or head movement, receiving help from a third party via a head set or someone nearby, patterned pauses and fluent answers as if reading rather than talking. In some embodiments, the system processes streaming video and audio data collected during the interview to analyze facial movements and voice patterns of the applicant and identify at least one of suspicious eye movement, head movement, patterned pauses, or use of a secondary device indicative of potential external assistance or fraudulent behavior. The analysis may further include detecting temporal patterns, response latency, and behavioral inconsistencies indicative of external assistance or scripted responses. The system may further evaluate consistency based on the analyzed streaming data, previously extracted resume data, and generated test responses across multiple data modalities.

Next, the system 900 performs behavior fraud detection via the behavior fraud detection module 908. If fraud is detected as a result of the AI analysis, then the system 900 will generate test questions against the job applicants resume skill set and against the job requirements via an LLM model at the AI test module 909, the system 900 also applies retrieval-augmented generation (RAG) to customize questions using the job description and other company associated information and using a prompting template to standardize the format and style of the questions and transmit those questions to behavior fraud detection module 908 for deployment. In some embodiments, retrieval-augmented generation (RAG) is used to improve the accuracy and relevance of outputs generated by machine learning models of the system 900. The system 900 may retrieve relevant data from one or more external data sources 90 using structured or semi-structured data generated by the information extraction module 106 of system 100, and incorporate the retrieved data into prompting templates provided to a large language model (LLM). The large language model (LLM) may then generates responses, including test questions generated by the AI test module 909, structured outputs, or validation results, based on both the retrieved data and the input data. By combining retrieval of external data with generation capabilities of the large language model (LLM), the system can produce context-specific and data-informed outputs that improve consistency, mitigate hallucination, improve grounding, and enhance reliability of the hiring evaluation process.

In some embodiments, the generation of test questions is performed using machine learning models in combination with prompting templates that incorporate job requirements, resume data, and external reference data (via RAG) to generate context-specific question sets.

Based on the job applicant's answers, recommendations are made via the recommendation module 910 and the system 900 also calculates psychometric measurements via the measurement/calculations module 912 (similar that performed by the comparison module 110 of system 100) using a model and presents the results visually, and the results are then stored in the data store 913. The results are displayed to the HR recruiters so that they can decide whether to accept or reject the job applicant. As previously mentioned above similar to system 100 shown in FIG. 1, in system 900 when the results are displayed to the HR recruiters at the user device 50, they include an approval, decline or follow up recommendation and this recommendation is based on the AI model generating a value based on the job applicant's behavior and performance during the job interview. For example, if the value is greater than an accept threshold (e.g., 0.9), the AI model will suggest approval (or accept), if the value is less than a reject threshold (e.g., 0.6), the AI model will suggest decline (or reject) and if the value is in between the accept threshold and the reject threshold, the AI model suggest a follow up (or another round, manual check etc.). Based on different situations, the HR recruiter (or user) of the system 900 could adjust the thresholds to meet their needs according to one or more embodiments. For example, if there is a lack of HR recruiters, or to reduce recruiting costs, the thresholds may be close to each other or the same, to reduce or eliminate a follow up recommendation. If there may be a large pool of job applicants, the user may set the reject threshold high to only pass the best or perfectly matched candidates for the job. Alternatively, the user may set the accept threshold low if they are willing to train a new employee, and therefore receive a larger number of candidates for consideration.

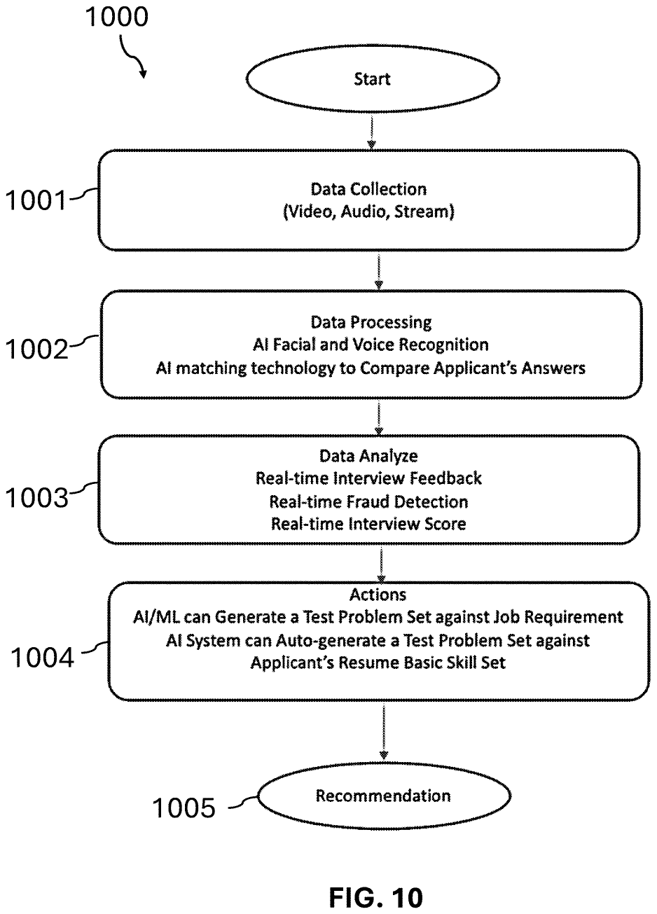

FIG. 10 is a flow diagram illustrating a method 1000 for conducting the job interviews for applicants using the system 900 shown in FIG. 9, according to another embodiment of the present disclosure. As shown in FIG. 10, the method 1000 begins at operation 1001, where data collection is performed in real-time, by video streaming, interview audio streaming, and interview question streaming. According to an embodiment, custom, personalized, and in-context questions and answer pairs can be generated using resume datasets.

From operation 1001, the process continues to operation 1002, where real-time data from streaming processes is processed using AI facial and voice recognition technology to analyze the applicant's behavior. AI matching technology is used to compare the applicant's answers. The process continues to operation 1003, where the data is analyzed in real-time to evaluate reliability, validity, and consistency of the interview answers. The objectives are to provide real-time interview feedback, fraud detection, and an interview score.

According to an embodiment, psychometric measurements can be calculated using answer comparisons (e.g., group or individual). A chart can be provided to represent the resume answers versus actual or real answers (e.g., the graph 810 depicted in FIG. 8B). At operation 10084, as a result of the data analyzed various actions can be taken, the system 900 can generate a test problem set against the job requirement, or auto-generate a test problem within the applicant's skillset provided on the resume using AI and ML technologies. From operation 1004, the method 1000 continues to operation 1005, where recommendations can be provided based on the interview score.

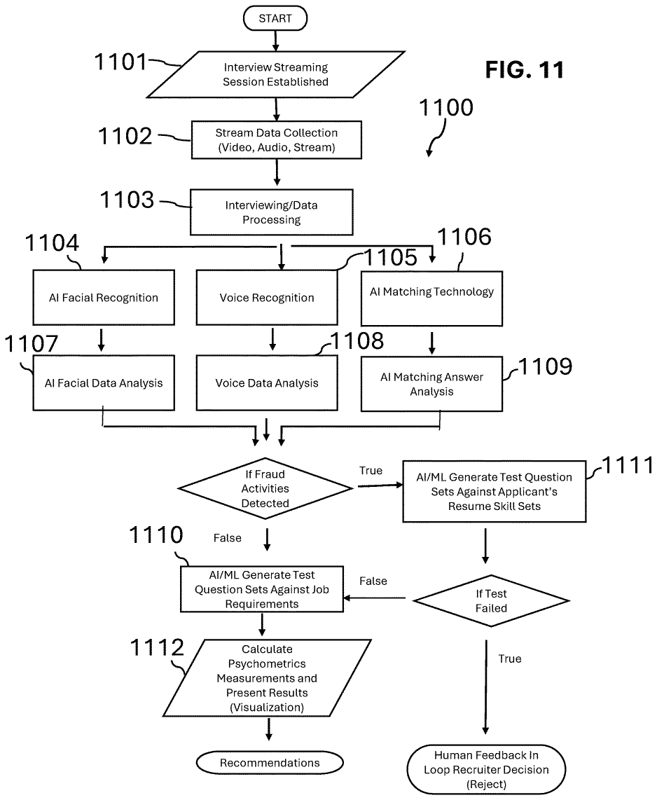

FIG. 11 is a flow diagram that illustrates a more detailed method 1100 of the method 1000 shown in FIG. 10, for conducting job interviews according to one or more embodiments of the present disclosure. The method 1100 starts at operation 1101 where the interview streaming session is first established. Then, at operation 1102, video, audio and streaming data are collected. The data is then processed at operation 1103-1109, as shown, AI recognition (e.g., matching) is performed including facial and voice recognition at operations 1104 and 1105 and the matching thereof at operation 1106, the AI facial and voice data results including e.g., facial movements and voice patterns are then analyzed and verified at operations 1107, 1108 and 1109. For example, as previously mentioned above, to analyze facial data, it may be determined whether the job applicant turned off their camera (video) or had suspicious eye or head movement or a secondary screen device (e.g., a laptop or mobile device) nearby or on the screen during the interview (e.g., via Zoom). To analyze voice, it may be determined whether there are any patterned pauses and then fluent perfect answers; it may also be determined whether the job applicant is reading rather than talking; and/or possible use of a headset to obtain help from a third-party, may be detected if the job applicant repeats the question being asked. If fraud is not detected, at operation 1110 AI/ML test questions are generated against the job requirements and the answers to the questions are used to calculate psychometric measurements at operation 1112 and the results are presented to the HR recruiter along with recommendations, If fraud is detected at operation 1109, then at operation 1111 AI/ML test questions sets are generated against the applicants resume skill set, for example, and if the applicant passes the applicant resume skill set test questions, then at operation 1110, AI/ML generated test question sets are generated against the job requirements and at operation 1112 the psychometrics measurements are calculated and recommendations are displayed to the HR Recruiter. Alternatively, if the applicant fails the applicant skill set test questions, human feedback is looped into the HR recruiter's decision as to whether to reject the applicant based on detected fraud.

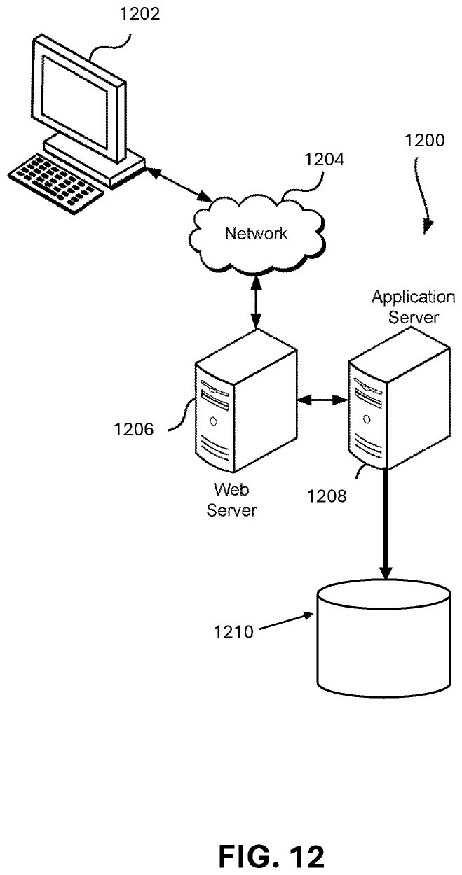

FIG. 12 presents a block diagram of the computer system 1200, which includes a display 1202, communication network 1204, web server 1206, application server 1208, and storage device 1210. This system architecture supports the operation and management of the user device 50 and the systems 100 and 900 (as depicted in FIGS. 1 and 9). The environment 1100 can be a cloud storage environment. As will be appreciated, although a web-based environment is used for purposes of explanation, different environments may be used, as appropriate, to implement various embodiments.

The environment 1200 includes an electronic device 1202, which can include any appropriate device operable to send and/or receive requests, messages, or information over an appropriate network 1204 and, in some embodiments, convey information back to a user of the device. Examples of such electronic devices 1202 include personal computers, cell phones, handheld messaging devices, laptop computers, tablet computers, set-top boxes, personal data assistants, embedded computer systems, electronic book readers, and the like.

The network 1204 can include any appropriate network, including an intranet, the Internet, a cellular network, a local area network, a satellite network, or any other such network and/or combination thereof. Components used for such a system can depend, at least in part, upon the type of network and/or environment selected. Many protocols and components for communicating via such a network are well-known and will not be discussed herein in detail.

Communication over the network 1204 can be enabled by wired or wireless connections and combinations thereof. In this example, the network 1204 includes the Internet and/or other publicly addressable communications network. The environment includes a web server 1206 for receiving requests and serving content in response thereto, although, for other networks, an alternative device serving a similar purpose could be used as would be apparent to one of ordinary skill in the art.

The illustrative environment includes at least one application server 1208 and a data store 1210. It should be understood that there can be several application servers, serverless services, layers, or other elements, processes, or components, which may be chained or otherwise configured, which can interact to perform tasks such as obtaining data from an appropriate data store. Servers, as used herein, may be implemented in various ways, such as hardware devices or virtual computer systems. In some contexts, servers may refer to a programming module being executed on a computer system.

As used herein, unless otherwise stated or clear from context, the term “datastore” or “data store” refers to any device or combination of devices capable of storing, accessing, and retrieving data, which may include any combination and number of data servers, databases, data storage devices, and data storage media, in any standard, distributed, virtual, or clustered environment.

The application server 1208 can include any appropriate hardware, software, and firmware for integrating with the data store 1210 as needed. The hardware, software, and firmware may execute aspects of one or more applications for the electronic device 1202, handling some or all of the data access and business logic for an application.

The application server 1208 may provide access control services in cooperation with the data store 1210 and is able to generate content. The content may include text, graphics, audio, video, and/or other content that is usable, to be provided to the user, which may be served to the user by the web server 1206. The content may be served in the form of Hypertext Markup Language (HTML), Extensible Markup Language (XML), JavaScript, Cascading Style Sheets (CSS), JSON, and/or another appropriate client-side structured language.

Content transferred to the electronic device 1202 may be processed by the electronic device 1202 to provide the content in one or more forms including, but not limited to, forms that are perceptible to the user audibly, visually, and/or through other senses. The handling of all requests and responses, as well as the delivery of content between the electronic device 1202 and the application server 1208, can be handled by the web server 1206 using

Hypertext Preprocessor (PHP), Python, Ruby, Perl, Java, HTML, XML, JSON, and/or another appropriate server-side structured language in this example. Further, operations described herein as being performed by a single device may, unless otherwise clear from context, be performed collectively by multiple devices, which may form a distributed and/or virtual system.

The environment, in one embodiment, is a distributed and/or virtual computing environment utilizing several computer systems and components that are interconnected via communication links, using one or more computer networks or direct connections. However, it will be appreciated by those of ordinary skill in the art that such a system could operate equally well in a system having fewer or a greater number of components than are illustrated in FIG. 12. Thus, the depiction of the system illustrated in the example environment 1200 in FIG. 12 should be taken as being illustrative in nature and not limiting to the scope of the disclosure.

Where a system includes computerized devices, each such device can include hardware elements that may be electrically coupled via a bus, the elements including, for example, at least one central processing unit (CPU) or processor, at least one input device (e.g., a mouse, keyboard, controller, touch screen, or keypad), and at least one output device (e.g., a display device, printer, or speaker). Such a system may also include one or more storage devices, such as disk drives, optical storage devices, and solid-state storage devices such as random access memory (RAM) or read-only memory (ROM), as well as removable media devices, memory cards, flash cards, etc.

Embodiments of the present disclosure integrate various modules and technologies to automate the decision-making and assembly process for legal content. The system leverages a content management system, decision engine, and intelligent language models of an LLM module to improve efficiency, reduce errors, and ensure compliance with marketing materials.

Although the disclosure has been described with reference to several exemplary embodiments, it is understood that the words that have been used are words of description and illustration, rather than words of limitation. Changes may be made within the purview of the appended claims, as presently stated, and as amended, without departing from the scope and spirit of the present disclosure in its aspects. Although the disclosure has been described with reference to particular means, materials, and embodiments, the disclosure is not intended to be limited to the particulars disclosed. Rather, the disclosure extends to all functionally equivalent structures, methods, and uses such as are within the scope of the appended claims.

For example, while the computer-readable medium (CRM) may be described as a single medium and includes a single medium or multiple media, such as a centralized or distributed database, and/or associated caches and servers that store one or more sets of instructions. The term CRM may also include any medium capable of storing, encoding or carrying a set of instructions for execution by a processor or that cause a computer system to perform any one or more of the embodiments disclosed herein.

The CRM may comprise a non-transitory CRM or media and/or comprise a transitory CRM or media. In a particular non-limiting, exemplary embodiment, the CRM can include a solid-state memory such as a memory card or other package that houses one or more non-volatile read-only memories.

Further, the CRM can be a random-access memory or other volatile re-writable memory. Additionally, the CRM can include a magneto-optical or optical medium, such as a disk or tape or other storage device to capture carrier wave signals such as a signal communicated over a transmission medium. Accordingly, the disclosure is considered to include any computer-readable medium or other equivalents and successor media, in which data or instructions may be stored.

The present application describes specific embodiments that may be implemented as computer programs or code segments in computer-readable media. However, it is to be understood that dedicated hardware implementations, such as application-specific integrated circuits, programmable logic arrays, and other hardware devices, can be constructed to implement one or more of the embodiments described herein.

Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions.

Accordingly, replacement standards and protocols having the same or similar functions are considered equivalents thereof.

The illustrations of the embodiments described herein are intended to provide a general understanding of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure.

Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “disclosure” merely for convenience and without intending to voluntarily limit the scope of this application to any particular disclosure or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments and other embodiments not specifically described herein will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above-disclosed subject matter is to be considered illustrative and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents and shall not be restricted or limited by the foregoing detailed description.

Embodiments of the present disclosure provide the benefits of integrating AI principles of fairness, reduced bias, transparency, and responsibility, by utilizing AI to filter, categorize, group, verify and match resume data against other reference sources, enhance resume quality scores by referencing additional resources, incorporates multiple data sources, including non-resume resources, historical changes, and non-resume data, thereby reducing the time and effort required for manual review processes by automating the resume screening process and adding value to existing processes. In some embodiments, validation recommendations are generated based on evaluated results and may include approval, decline, or follow-up determinations based on threshold values associated with similarity scores or interview performance metrics. This disclosure automates and enhances the accuracy of data validation processes in HR hiring by reducing the risk of fraud and improving the efficiency and reliability of candidate evaluations. Other embodiments of the present disclosure enhance the integrity check of reference contacts.

The description herein is provided to enable a person skilled in the art to make or use the disclosure. Various modifications to the disclosure will be apparent to those skilled in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. A system comprising:
a data processing module configured to extract raw resume data from resumes received using machine learning;
an information extraction module configured to retrieve key individual data from the extracted text and convert it into a structured format as source data for downstream processing;
a reference data retrieval module configured to query relevant individual data as reference data from external data sources using data output in the structured format from the information extraction module;
a comparison module configured to convert source data and reference data into vector embeddings using a machine learning model, and to conduct a semantic similarity search to calculate similarity scores between the vector embeddings; and
a recommendation module configured to generate validation recommendations based on the similarity scores.

2. The system of claim 1, further comprising an optical character recognition module configured to convert input data into editable text.

3. The system of claim 1, wherein the information extraction module is configured to generate the structured format as JavaScript Object Notation (JSON).

4. The system of claim 3, wherein the structured format includes key-value pairs representing at least one of name, address, education, or employment history.

5. The system of claim 1, wherein the reference data retrieval module is configured to retrieve data from public, paid, or proprietary external data sources.

6. The system of claim 1, wherein the comparison module is configured to calculate cosine similarity between the vector embeddings.

7. The system of claim 1, wherein the recommendation module is configured to generate validation recommendations including approve, decline, or follow-up.

8. The system of claim 1, further comprising a reinforcement learning module configured to evaluate output results against expected results, apply a reward value to accurate outputs and a penalty value to inaccurate or unrelated outputs, and iteratively update model weights using a feedback loop.

9. A method for detecting and preventing data fraud in a hiring process, comprising:
receiving resumes from a user device;
extracting raw resume data from the resumes using machine learning;
converting the raw resume data into machine-readable text;
retrieving key individual data from the extracted text and converting the key individual data into a structured format as source data;
querying relevant individual data as reference data from external data sources using the structured format;
converting the source data and the reference data into vector embeddings using a machine learning model;
conducting a semantic similarity search to calculate similarity scores between the vector embeddings; and
generating validation recommendations based on the similarity scores.

10. The method of claim 9, wherein extracting raw resume data includes converting input data into editable text using an optical character recognition module.

11. The method of claim 9, wherein extracting raw resume data includes using multiple machine learning models to cross validate extracted text and exclude inconsistent or inaccurate extracted data.

12. The method of claim 9, wherein converting key individual data into the structured format includes generating data in a JavaScript Object Notation (JSON) format.

13. The method of claim 9, further comprising evaluating output results against expected results, applying a reward value to accurate outputs and a penalty value to inaccurate or unrelated outputs, and iteratively updating model weights using a feedback loop based on the reward and penalty values.

14. The method of claim 9, wherein querying reference data includes retrieving data from public, paid, or proprietary external data sources.

15. The method of claim 9, wherein the semantic similarity search includes calculating cosine similarity between vector embeddings.

16. The method of claim 9, wherein querying relevant individual data includes retrieving external data and incorporating the retrieved data into prompting templates provided to a language model to generate context-specific outputs.

17. A method for conducting job interviews for applicants, comprising:
collecting streaming data including video, audio, and interview data;
processing the streaming data using artificial intelligence facial and voice recognition;
analyzing facial movements and voice patterns of an applicant;
detecting behavior fraud based on the analysis;
generating test questions using a machine learning model based on at least one of job requirements and applicant resume skill sets;
evaluating applicant responses based on the analysis;
calculating psychometric measurements; and
generating validation recommendations based on the evaluation.

18. The method of claim 17, wherein detecting behavior fraud includes analyzing facial movements and voice patterns of the applicant to identify at least one of suspicious eye movement, head movement, patterned pauses, or use of a secondary device.

19. The method of claim 17, wherein generating test questions includes using a machine learning model with prompting templates based on job descriptions, and wherein psychometric measurements are calculated based on applicant responses to generate validation recommendations including approval, decline, or follow-up.

20. The method of claim 17, further comprising generating test question sets based on at least one of job requirements and applicant resume data and evaluating applicant responses using machine learning models.

21. A non-transitory computer-readable medium storing instructions that, when executed by one or more processors, cause the one or more processors to perform a method for detecting and
preventing data fraud in a hiring process, the method comprising:
receiving resumes from a user device;
extracting raw resume data from the resumes using machine learning;
converting the raw resume data into machine-readable text;
retrieving key individual data from the extracted text and converting the key individual data into a structured format as source data;
querying relevant individual data as reference data from external data sources using the structured format;
converting the source data and the reference data into vector embeddings using a machine learning model;
conducting a semantic similarity search to calculate similarity scores between the vector embeddings; and
generating validation recommendations based on the similarity scores.
